(19) United States
(12) Patent Application Publication
(10) Pub. No.: US 2025/0252291 A1
(43) Pub. Date: Aug. 7, 2025

(54) UNSUPERVISED DOMAIN ADAPTATION USING PROMPT LEARNING IN EDGE DEVICES

(71) Applicant: Dell Products L.P., Round Rock, TX (US)

(72) Inventors: Karen Stéfany Martins, Belo Horizonte (BR); Karen Braga Enes, Belo Horizonte (BR); Pablo Nascimento Da Silva, Niterói (BR); Iam Palatnik de Sousa, Rio de Janeiro (BR)

(73) Assignee: Dell Products L.P., Round Rock, TX (US)

(21) Appl. No.: 18/431,258

(22) Filed: Feb. 2, 2024

(51) Int. Cl. G06N 3/0455; G06N 3/088

(52) U.S. Cl. CPC G06N 3/0455; G06N 3/088

(57) ABSTRACT

Techniques are disclosed for unsupervised domain adaptation using prompt learning in edge devices. An example system includes a memory having instructions, and a processor communicatively coupled to the memory and configured to execute the instructions. Example instructions include: comparing statistics of data samples collected from an edge device against a plurality of known domain statistics to detect a new domain; using descriptions generated for the collected data samples to determine a pseudo label associated with the new domain, where the pseudo label is generated using unsupervised machine learning; and applying a domain adaptation process using prompt learning based on the new domain and on the associated pseudo label to generate new prompts usable with a machine learning multimodal model for the new domain, and to update the known domain statistics to include statistics of the new domain, where the multimodal model is trained on text similarity.

### FIELD

Example embodiments generally relate to machine learning in edge computing. More specifically, at least some embodiments relate to systems, hardware, software, computer-readable media, and methods for enabling machine learning models to adapt to new domains without the need for labeled data.

### BACKGROUND

Edge computing refers to the practice of processing data near the edge of the network, where the data is being generated, rather than in a centralized data-processing warehouse. This approach is beneficial for real-time data processing applications such as autonomous vehicles, smart cities, and Internet of Things (IoT) devices, where low latency and local computation are beneficial.

In the realm of machine learning, a common challenge is the adaptation of models to new, unseen domains without extensive retraining or manual data labeling. Models are typically trained on large, labeled datasets that represent a specific domain. However, when deployed in the real world, these models often encounter data that differ significantly from the training data, leading to a decrease in performance. This phenomenon is known as domain shift. Conventional approaches to address domain shift involve supervised learning techniques that require labeled data from the new domain, which can be costly and time-consuming to obtain.

Unsupervised domain adaptation aims to adapt a pre-trained model to a new domain without the need for labeled data from that domain. This is particularly relevant for edge devices that operate in dynamic environments and must continuously adapt to new conditions without human intervention.

### SUMMARY

Techniques are disclosed for unsupervised domain adaptation using prompt learning in edge devices.

In one embodiment, a system includes a memory having instructions, and a processor communicatively coupled to the memory and configured to execute the instructions. The instructions can include: comparing statistics of data samples collected from an edge device against a plurality of known domain statistics to detect a new domain; using descriptions generated for the collected data samples to determine a pseudo label associated with the new domain, where the pseudo label is generated using unsupervised ML; and applying a domain adaptation process using prompt learning based on the new domain and on the associated pseudo label to generate new prompts usable with a ML multimodal model for the new domain, and to update the known domain statistics to include statistics of the new domain, where the multimodal model is trained on text similarity.

In some embodiments, the descriptions for the collected data samples are generated by applying a plurality of ML image-to-text models to the collected data samples. Using descriptions generated for the collected data samples can further include: obtaining a general LLM and a text prompt configured to analyze image descriptions; applying the LLM and the text prompt to the descriptions generated by the image-to-text models for the collected data samples to define domains for each image; and selecting a label for a defined domain that is identified as predominant, to be the associated pseudo label, where the predominant domain is identified based on a frequency of domain occurrence in the generated descriptions. The domain adaptation process can be unsupervised. The multimodal model trained on text similarity can be a ML contrastive learning model. The domain adaptation process can further include: obtaining a set of known classes corresponding to the known domains; and where the new prompts for the new domain are generated using the contrastive learning model, and the contrastive learning model is trained with a contrastive objective configured to align corresponding images and text representations of the known classes and the known domains in a shared feature space. The contrastive objective can be further configured to maximize a similarity measure between a given image and a particular corresponding text representation as a positive pair, and to minimize the similarity measure between the given image and other text representations that are determined to be irrelevant as negative pairs. The similarity measure can be a cosine similarity. The domain adaptation process can be DAPL. The edge device can be a camera in a connected car, and the data samples can include image data from the camera.

Other example embodiments include, without limitation, apparatus, systems, methods, and computer program products comprising processor-readable storage media.

Other aspects will be apparent from the following detailed description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIG. 1 discloses aspects of an example machine learning prediction, in accordance with illustrative embodiments.

FIG. 2 discloses aspects of an example representation of data domains and prompts, in accordance with illustrative embodiments.

FIG. 3 discloses aspects of example machine learning training, in accordance with illustrative embodiments.

FIG. 4 discloses aspects of an example application scenario, in accordance with illustrative embodiments.

FIG. 5 discloses aspects of an example adaptation architecture, in accordance with illustrative embodiments.

FIGS. 6, 7, 8, 9, and 10 disclose flowcharts of example methods, in accordance with illustrative embodiments.

FIG. 11 discloses aspects of a computing entity configured and operable to perform any of the disclosed methods, processes, and operations, in accordance with illustrative embodiments.

### DETAILED DESCRIPTION

Example embodiments generally relate to machine learning in edge computing. More specifically, at least some embodiments relate to systems, hardware, software, computer-readable media, and methods for enabling machine learning models to adapt to new domains without the need for labeled data.

Disclosed herein are techniques for unsupervised domain adaptation by leveraging prompt learning-based techniques. In general, the present solution is configured to detect a domain shift, label new data in an unsupervised manner, and adapt an existing model to the new domain efficiently without the need for manual intervention or extensive retraining.

In example embodiments, the present adaptation pipeline is configured to gather data from edge devices, such as cameras on autonomous vehicles. In one implementation, the adaptation pipeline is configured to utilize statistical analysis to compare the collected data against known domain statistics to detect any domain shifts. Once a new domain is detected, the adaptation pipeline is configured to employ a set of pretrained image-to-text models to generate descriptions of the data samples, which are then used to identify a predominant domain.

In example embodiments, the present adaptation pipeline is configured to receive a multimodal model pretrained on text similarity and a dataset of prompts for each known domain. In one implementation, the adaptation pipeline is configured to apply a domain adaptation process. In example embodiments, the domain adaptation process uses Domain Adaptation via Prompt Learning (DAPL). DAPL generally involves the use of prompts that are tailored to the specific characteristics of the new domain, allowing the model to align image and text representations in a shared feature space.

In example embodiments, the present adaptation pipeline is configured to update the known domain statistics with the new domain information, ensuring that the present system can continue to adapt to future domain shifts. The present system is configured to generate pseudo labels for the new domain dataset, for example using zero-shot inference, which further reduces the need for labeled data.

Conventional approaches have included various forms of transfer learning and domain adaptation techniques. However, these conventional methods often require some form of supervision or are limited in their ability to handle significant domain shifts.

In an autonomous vehicle scenario, each vehicle has a set of devices (e.g., cameras, sensors) that runs a model trained on a specific dataset for the application domain of that specific edge. Edge devices may cover some specific geographic locations, depending on the vehicle route, traffic conditions and local weather, to enumerate a few. Commonly, the same trained model needs to be applied in different domains, such as tropical countries and constant winter regions like Siberia.

The disclosed techniques provide a technical solution to allow models trained in different domains to be able to adapt their behavior to a new and previously unseen domain in an unsupervised fashion, without retraining the model or manually labeling the data. Example embodiments leverage a prompt-based learning technique to transfer knowledge under domain shift constraints in an unsupervised fashion. In one implementation, the disclosed techniques start by first identifying a new domain, and second, labeling a target dataset from this new domain in an unsupervised way. Lastly, the disclosed techniques apply a domain adaptation process using prompt-based learning to train prompts for the new domain. In one example, the domain adaptation process is DAPL.

The present adaptation solution addresses the following technical problems:
1. Avoiding a need for labeled data when adapting the model to a new domain.
   a. Supervised learning relies highly on a large amount of labeled data. However, both collecting and labeling a large amount of data from different domains is computationally expensive. In many cases, there is no labeled data volume available for model training. In these cases, the collection and pre-processing of data may be temporarily unfeasible.
2. Identifying important features and objects in a new operating environment without human interference.
   a. In dynamic environments, there are unexpected objects, operator behaviors and other characteristics that are highly challenging to foresee. These characteristics should be addressed in the execution environment.
3. Automatically identifying domain changes and adapting a model to this new domain is not a trivial task.
   a. Often a large amount of information is needed to represent the new domain well. Also, identifying a new domain may require human efforts to analyze the data.
   b. Besides identifying the new domain, we also need to adapt the model to recognize it.

The disclosed techniques provide technical solutions to the technical problems discussed herein, including, but not limited to, the following:
1. A pipeline for leveraging prompt learning, for example by image environment descriptions, for performing domain adaptation whenever data drifts.
2. A method for automatically identifying a suitable edge operation environment based on image-to-text descriptions.

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### A. Context for an Example Embodiment

The following is a discussion of a context for example embodiments. This discussion is not intended to limit the scope of the invention, or the applicability of the embodiments, in any way.

### A.1. Prompt-Based Learning

Recently, the conventional pre-train and fine-tune paradigm has changed to “pre-train, prompt, and predict” and now such domain adaptation methods are based on prompt-based learning. In this paradigm, downstream tasks are reformulated to look like the task learned during the original language model (LM) training. To perform this reformulation, the text input is modified using prompts. Such prompt-based learning allows large LMs to generalize tasks that they were not trained on, with minimal data and performance comparable to fine-tuning the LM model to the target task. Unlike a conventional fine-tuning paradigm, a single pre-trained model can be applied to different tasks, reducing computational costs.

Prompt learning can be generalized to three steps. The first step, called prompt engineering, applies a function to modify the original input, which uses a template with two empty slots, an input slot [x] and an answer slot [z]. The input slot [x] is filled with the original input. For instance, considering a sentiment analysis task, given the template “[X] The movie is [Z]” and the input “I love this movie.”, the result will be “I love this movie. The movie is [Z].”

In the second step, answer search, the paradigm defines a set of permissible answers Z. Building on the sentiment analysis example, an example set is Z={great, fantastic, bad, . . . }. Then, the paradigm searches over Z, looking for the highest scoring text that maximizes the score of the pre trained LM.

Finally, in the third step, answer mapping, the paradigm transforms the highest scoring answer to the highest scoring output. For example, if the highest scoring answer for the input “I love this movie.” is “great”, the final output would be “positive” instead of “negative”. Table 1 shows these three steps.

TABLE 1

| Name | Notation | Example | Description |
|---|---|---|---|
| Input | x | I love this movie. | One or multiple |
| | | | texts |
| Output | y | ++ (very positive) | Output label or text |
| Prompting | fₚᵣₒₘₚₜ(x) | [X] Overall, it was | A function that |
| Function | | a [Z] movie. | converts the input |
| | | | into a specific form |
| | | | by inserting the |
| | | | input x and adding |
| | | | a slot [Z] where |
| | | | answer z may be |
| | | | filled later. |
| Prompt | x′ | I love this movie. | A text where [X] is |
| | | Overall, it was a | instantiated by |
| | | [Z] movie. | input x but answer |
| | | | slot [Z] is not |
| Filled | f_{fill}(x′, z) | I love this movie. | A prompt where |
| Prompt | | Overall, it was a | slot [Z] is filled |
| | | bad movie. | with any answer |
| Answered | f_{fill}(x′, z*) | I love this movie. | A prompt where |
| Prompt | | Overall, it was a | slot [Z] is filled |
| | | good movie. | with a true answer |
| Answer | z | “good,” “fantastic,” | A token, phrase, or |
| | | “boring” | sentence that fills |
| | | | [Z] |

Prompts can be manually created based on human introspection or automatically generated. Usually they have comparable performance, at the cost of interpretability and computational efforts.

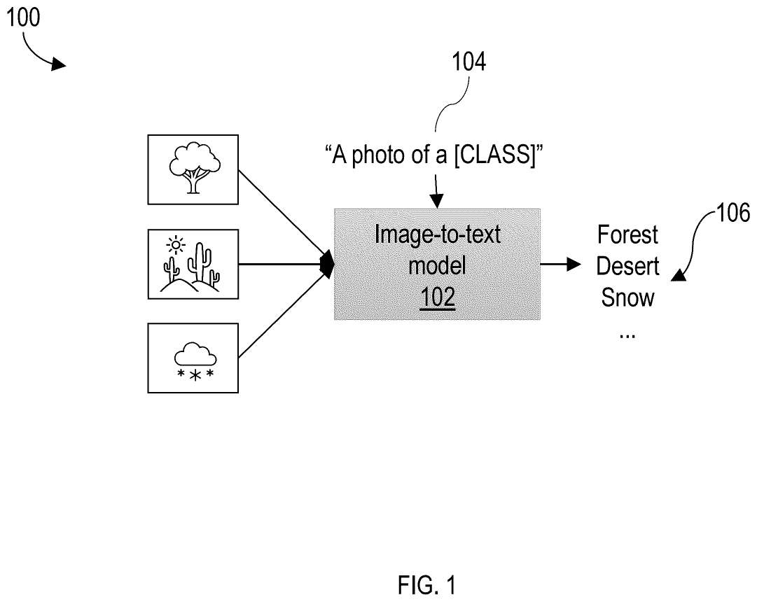

FIG. 1 shows aspects of an example machine learning (ML) prediction 100, in accordance with illustrative embodiments. In particular, FIG. 1 shows an example zero-shot setting.

FIG. 1 shows an example zero-shot image-to-text prediction 100 using an LLM 102 and prompt 104. In the zero-shot setting, the paradigm can directly apply the LM to predict 106 a new input without any express training for the downstream task. For instance, given an image-to-text model 102 and an image of a dog, the prompt can use the prompt “a photo of a [CLASS]” and the model to classify 106 the image (for example, as a dog) without any additional express training.

### A.2. Unsupervised Domain Adaptation

The unsupervised domain adaptation problem focuses on adapting a model trained from a well-annotated source domain to an unlabeled target domain. A technique called Domain Adaptation via Prompt Learning is configured to use prompt learning to address this unsupervised domain adaptation problem. Further details around DAPL are provided in Ge, Chunjiang, et al., “Domain adaptation via prompt learning,” arXiv preprint arXiv: 2202.06687 (2022), the entire contents of which are incorporated by reference herein for all purposes.

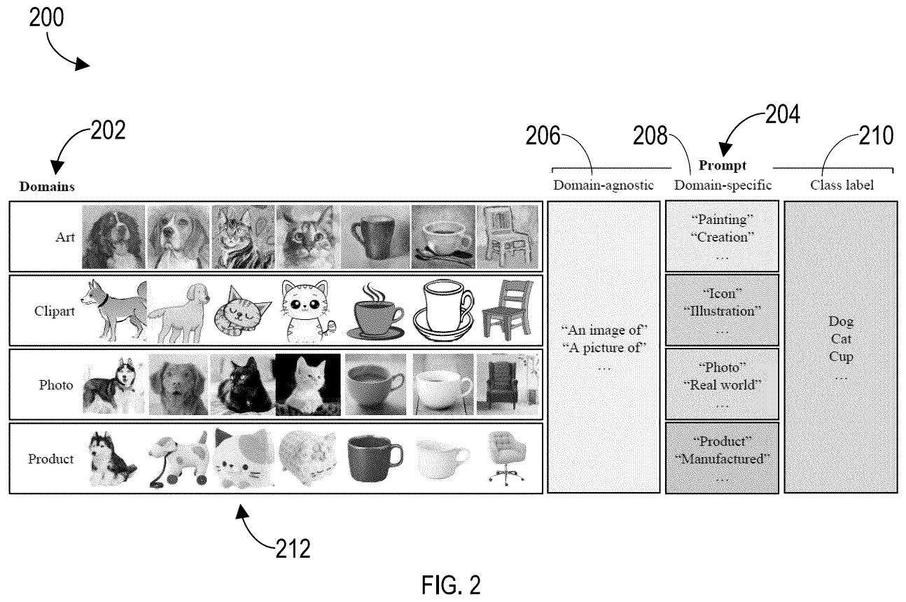

FIG. 2 shows aspects of an example representation 200 of data domains 202 and prompts 204, in accordance with illustrative embodiments. In particular, FIG. 2 shows an example prompt structure.

In example embodiments, in the representation 200, the data domains 202 and the prompts 204 are used for training an unsupervised domain adaptation method. The first two parts 206, 208 of the prompt are continuous and learned from data.

Generally, example embodiments of DAPL consider a prompt 204 to be divided in multiple parts 206, 208, 210. Example parts include, but are not limited to, the following: domain-agnostic context 206, domain specific context 208, and class label 210 (token). For example, given the prompt “An image of a painting Dog”, the words “An image of” represent general task information shared by all images (domain-agnostic context). “A painting” represents the domain information, and “dog” represents the class label.

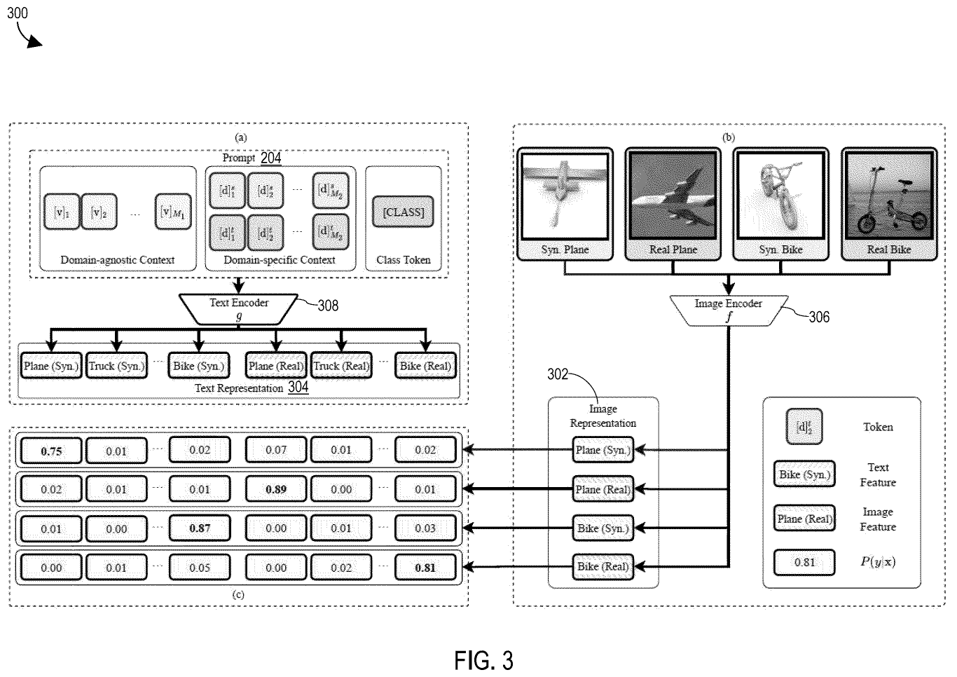

FIG. 3 shows aspects of example machine learning training 300, in accordance with illustrative embodiments. More particularly, FIG. 3 shows an example domain adaptation process 300 using prompt learning.

With reference to FIGS. 2 and 3, in one implementation, the model is trained using a contrastive objective in which the goal is to align the image representation 302 and the text representation 304 in the same feature space. In example embodiments, to perform that alignment, the method 300 includes applying an image encoder 306 and a text encoder 308 to the image input 212 and the text input 204, respectively. In some embodiments, the method 300 includes maximizing the cosine similarity between a given image and its corresponding text (positive pair) and minimizing the cosine similarity between the image and the other, irrelevant, text descriptions (negative pair). In this way, the model can perform a zero-shot inference, selecting the category with largest similarity.

In one implementation, after training the initial model with a well-annotated dataset, the method 300 includes generating pseudo labels for the target domain. In some cases, the pseudo label generation uses zero-shot inference with CLIP. In example embodiments, the method 300 includes choosing the classes with the maximum predicted probability. In example embodiments, the method 300 includes training the prompt of the target domain with the unlabeled target dataset and their respective pseudo labels.

### B. Overview of Aspects of an Example Embodiment

### B.1. Introduction

This section discusses an example scenario of connected cars to illustrate one application of the disclosed techniques. This section also provides an overview of example embodiments. This section concludes with individual discussions of each example phase of the adaptation pipeline.

### B.2. Connected Cars

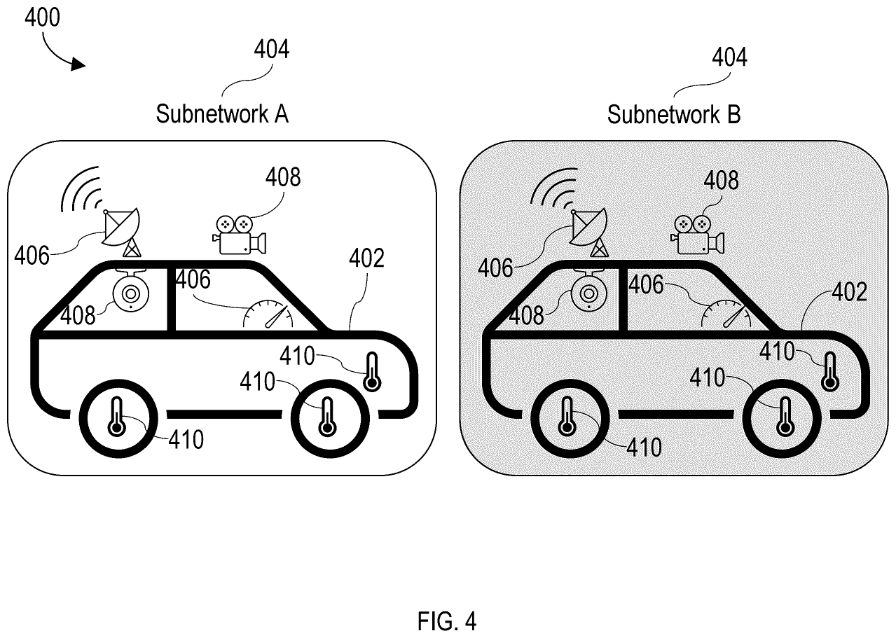

FIG. 4 shows aspects of an example application scenario 400, in accordance with illustrative embodiments. More particularly, the application scenario includes an illustration involving connected cars 402.

Example embodiments have utility in connection with an application scenario 400 of a network 404 of connected cars 402 modeled as a network of multiple edge devices. In each car, there is a limited number of sensors 406 that are considered edge devices, such as but not limited to cameras 408, thermometers 410, and the like. These devices sometimes generate redundant data, such as different angles of the same street, or temperature variations within the same region. FIG. 4 illustrates an example connected cars scenario 400.

Additionally, in example embodiments each edge device runs one or more learning models trained on a specific dataset for the application domain of that specific edge device. In the connected cars scenario, different groups of vehicles cover different, but specific geographic locations, depending on vehicle route, traffic conditions, and local weather, to enumerate a few. Commonly, the same trained model needs to be applied in different domains, such as tropical countries like Brazil or constant winter regions like Siberia.

### B.3. Example Phases

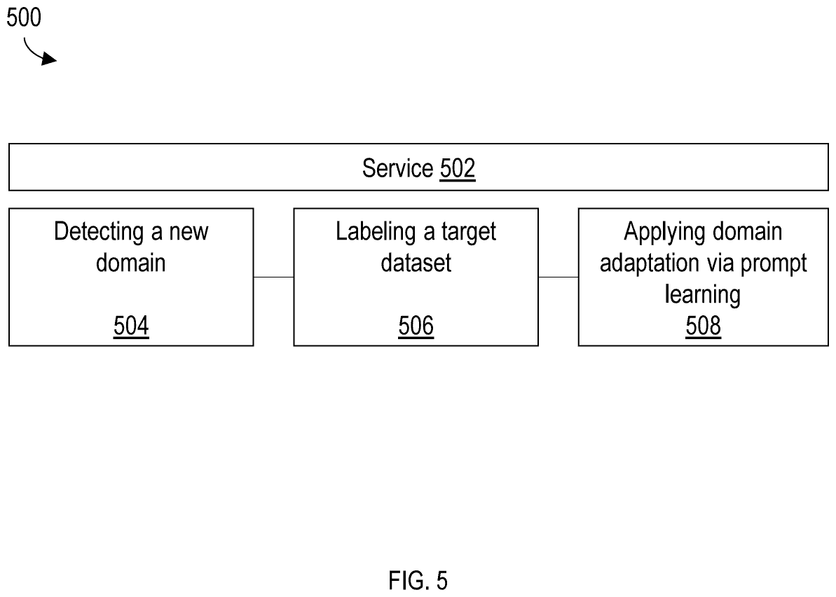

FIG. 5 shows aspects of an example adaptation solution 500, in accordance with illustrative embodiments. In particular, FIG. 5 illustrates the adaptation solution configured to process collected input data and generate prompts for domain adaptation.

In general, example embodiments deal with domain changing in image classification scenarios. In these scenarios, identifying a domain change and updating the model to address the new domain is a challenge, and if not automated, could require a large amount of human labor to label all the data or start the new domain. In one case, the adaptation pipeline 500 leverages image-to-text methods, to identify the domain changes, and in addition, applies a prompt-based learning method to avoid retraining the classification model from zero, advantageously saving computational resources, human-labor and leveraging modern technology.

In example embodiments, service 502 can implement the present adaptation techniques. As used herein, the term “service” refers to an automated program that is tasked with performing different actions based on input. In some cases, the service can be a deterministic service that operates fully given a set of inputs and without a randomization factor. In other cases, the service can be or can include a ML or artificial intelligence engine. The ML engine enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (SVM), artificial intelligence device(s), or any other type of intelligent computing system. Any amount of training data may be used (and perhaps later refined) to train the machine learning algorithm to dynamically perform the disclosed operations. As discussed in further detail herein, example training data can include collected input data such as image data.

In some implementations, the service 502 is a cloud service operating in a cloud environment. In some implementations, the service is a local service operating on a local device, such as a server. In some implementations, the service is a hybrid service that includes a cloud component operating in the cloud and a local component operating on a local device. These two components can communicate with one another.

FIG. 5 depicts an overview of example phases employed by the adaptation system 500. Example embodiments of the adaptation system use a pipeline configured to automatically identify and provide a domain adaptation over previous domains using a prompt-based learning paradigm. In one implementation, the adaptation system is divided into phases 504, 506, 508.

In a first phase 504, the present system 500 is configured to compare recently arrived data samples with already known domains to identify whether the data samples belong to a new domain or not.

An example first phase 504 is configured to detect a new domain. Example steps include, but are not limited to, the following:
1. Collect z data samples from the edge device to define Z as the set of collected data (e.g., images from an autonomous vehicle camera every one minute for two hours).
2. Collect statistics from z new data samples (e.g., such as data distribution).
3. Compare the current domain with the past ones using a table containing statistics from the n previously known domains, T={T₁, T₂, . . . , Tₙ}. Compare the current domain statistics to each Tᵢ∈T to identify some change in the distribution.
   a. If a new domain is identified, go to the second phase 506.
   b. Otherwise, we do not need to adapt the model.

In a second phase 506, if the data samples represent a new domain, then the present system 500 is configured to label the new domain. In one implementation, the disclosed techniques include applying a set of image-to-text models to search for a predominant domain on the data samples.

An example second phase 506 is configured to label a target dataset. Example steps include, but are not limited to, the following:
1. Obtain a set of m pretrained captioning models M={M₁, M₂, . . . , Mₘ}. In example embodiments, the captioning models can include, but are not limited to, a bootstrapping language-image pre-training model (BLIP) and image2prompt. Additional details around BLIP and image2prompt are disclosed in Li, Junnan, et al., “Blip: Bootstrapping language-image pre-training for unified vision-language understanding and generation”. International Conference on Machine Learning (2022), and Liu, Chang et al., “Image2Text: a multimodal image captioner”. Proceedings of the 24th ACM international conference on Multimedia (2016), respectively, the entire contents of each of which are incorporated by reference herein for all purposes.
2. Obtain a set of domains D={D₁, D₂, . . . , Dₙ} containing the n previously known domains.
3. Apply all m image-to-text models in the z collected images.
   a. For each image, run m models to generate m descriptions.
   b. Then, for each image i∈Z, we have a set Gⁱ={G₁ⁱ, G₂ⁱ, . . . , Gₘⁱ} containing m descriptions.
4. Generate image domains.
   a. From a general LLM and a text prompt capable of analyzing image descriptions and generating its domain.
   b. Apply the LLM and the text prompt on each of all z images and their descriptions Gⁱ to define its domain.
5. Select the predominant domain
   a. If the same domain appears in a predefined number of images, select it as the predominant domain.
   b. Otherwise, receive another text prompt and reapply the LLM to search for a predominant domain.
      i. If the LLM is not capable of finding the predominant domain, return to the first phase 504 and collect more data.
      ii. Otherwise, go to the third phase 508 to adapt the model.

In a third phase 508, the present system 500 is configured to apply a domain adaptation method, for example using prompt learning, to adapt the model to the new identified domain.

An example third phase 508 is configured to apply domain adaptation via prompt learning. Example steps include, but are not limited to, the following:
1. Obtain a multi modal model pretrained on text similarity (e.g., CLIP).
2. Obtain a set C={C₁, C₂, . . . , Cⱼ} containing the j known classes.
3. Obtain a dataset of prompts for each domain.
4. Obtain the z data samples and its predominant domain.
5. Apply a domain adaptation process using prompt learning to train the prompts for the new domain. In one implementation, the domain adaptation process is DAPL.
6. Update table T and set D with the new domain.

Each phase 504, 506, 508 is discussed in further detail herein.

### C. Detailed Description of Aspects of an Example Embodiment

### C.1. Example Methods

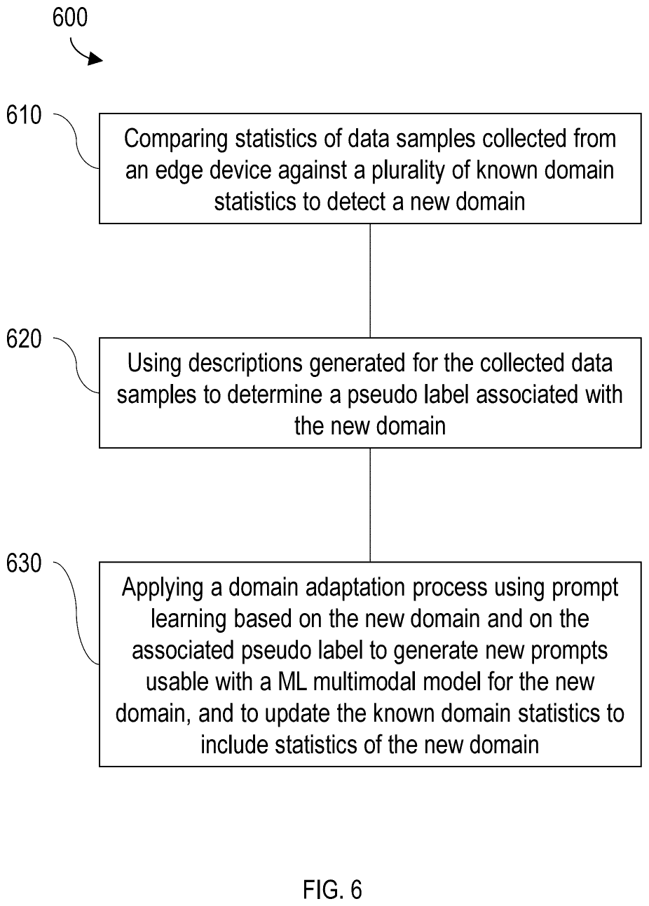

FIG. 6 shows a flowchart of an example method 600, in accordance with illustrative embodiments. In example embodiments, the method 600 allows for improved domain adaptation by leveraging prompt learning.

In example embodiments, the method 600 includes comparing statistics of data samples collected from an edge device against a plurality of known domain statistics to detect a new domain (step 610). In some embodiments, the edge device is a camera in a connected car, and the data samples include image data from the camera.

In example embodiments, the method 600 includes using descriptions generated for the collected data samples to determine a pseudo label associated with the new domain (step 620). In some embodiments, the pseudo label is generated using unsupervised ML. In some embodiments, the descriptions for the collected data samples are generated by applying a plurality of ML image-to-text models to the collected data samples. In further embodiments, using descriptions generated for the collected data samples further includes: obtaining a general LLM and a text prompt configured to analyze image descriptions; applying the LLM and the text prompt to the descriptions generated by the image-to-text models for the collected data samples to define domains for each image; and selecting a label for a defined domain that is identified as predominant, to be the associated pseudo label, where the predominant domain is identified based on a frequency of domain occurrence in the generated descriptions.

In example embodiments, the method 600 includes applying a domain adaptation process using prompt learning based on the new domain and on the associated pseudo label to generate new prompts usable with a ML multimodal model for the new domain, and to update the known domain statistics to include statistics of the new domain (step 630). In some embodiments, the multimodal model is trained on text similarity. In some embodiments, the domain adaptation process is unsupervised. In further embodiments, the multimodal model trained on text similarity is a ML contrastive learning model. In still further embodiments, the domain adaptation process further includes: obtaining a set of known classes corresponding to the known domains; and where the new prompts for the new domain are generated using the contrastive learning model, and the contrastive learning model is trained with a contrastive objective configured to align corresponding images and text representations of the known classes and the known domains in a shared feature space. In yet further embodiments, the contrastive objective is further configured to maximize a similarity measure between a given image and a particular corresponding text representation as a positive pair, and to minimize the similarity measure between the given image and other text representations that are determined to be irrelevant as negative pairs. In still further embodiments, the similarity measure is a cosine similarity. In yet further embodiments, the domain adaptation process is DAPL.

### c.2. Example Pipeline

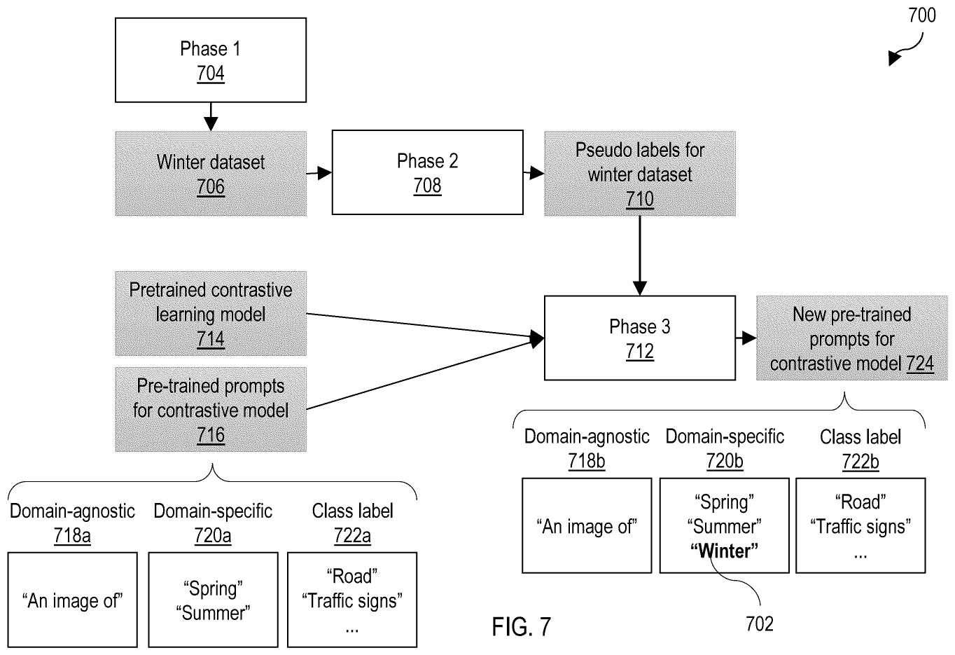

FIG. 7 shows a flowchart of an example method 700, in accordance with illustrative embodiments.

In the connected cars scenario discussed herein, one implementation applies DAPL, or any other prompt learning-based method for domain adaptation, to train a new domain specific prompt 702 called “winter,” for example, which can detect the same objects (classes) in the new domain. FIG. 7 shows an example full pipeline 700 to adapt the model for the new domain “winter” in the connected cars example.

In one embodiment, Phase 1 704 begins by identifying a new domain and obtaining the winter dataset (step 706). Phase 2 708 proceeds to obtain pseudo labels (step 710) for the winter dataset. Then, Phase 3 712 receives the pseudo labels 710, the multimodal model pretrained on text similarity 714 (also known as a contrastive learning model), and the pre-trained prompts 716 for the model, and applies the received inputs. More particularly, Phase 3 proceeds to apply a prompt learning-based method to adapt 724 the model 714 to the new domain. In one implementation, the prompt learning-based method is DAPL.

Example embodiments of DAPL contain prompts in which each prompt is divided into three parts 718, 720, 722. An example first part 718a, 718b (collectively, first part 718) contains a domain-agnostic context such as “An image of.” An example second part 720a, 720b (collectively, second part 720) contains a domain-specific context “spring” and “summer.” An example third part 722a, 722b (collectively, third part 722) contains the class labels such as “road”, “traffic signs,” and “pedestrians.” Example embodiments adapt the model (step 724) to recognize the same class labels 722b (objects) in winter locations.

### C.2.1 Phase 1—Domain Detection

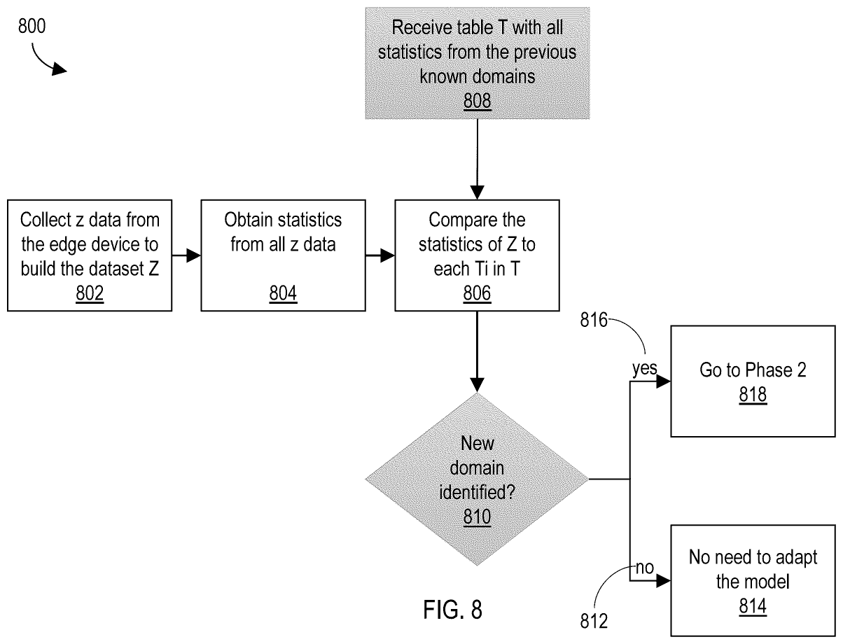

FIG. 8 shows a flowchart of an example method 800, in accordance with illustrative embodiments. In particular, FIG. 8 shows an example overview of the domain detection phase.

In example embodiments, in this phase 800 one objective is to detect a new domain, by collecting data and comparing the collected data with known domains, for example, all domains that have already been seen.

In example embodiments, the method 800 includes collecting new data for a regular and predefined time interval to build a set of new data Z containing z images (step 802). In some embodiments, the adaptation pipeline collects images from a camera in every minute for two hours in the morning, afternoon, and night every day. In some cases, one way to collect the dataset in the connected cars scenario is to use different vehicles to drive across the new scenario and capture images in different locations and angles.

In example embodiments, the method 800 includes obtaining statistics from the new collected data that was previously defined by the development team (step 804). In some embodiments, the statistics include a data distribution, or other statistical measures that define the collected dataset. In some cases, the statistics of all previously identified domains in the set of domains D={D₁, D₂, . . . , Dₙ} are allocated in a table T={T₁, T₂, . . . , Tₙ} stored on the edge. Advantageously, example embodiments allow for concentrating the information from the domains, and allow for searching and comparing the new dataset with data that has already been observed. Further, it is not necessary to store all data collected from all domains in the table. Storing data statistics, such as distributions for example, is enough for the comparison to be done properly and avoids being computationally expensive.

In example embodiments, the method 800 includes comparing these statistics that represent the domain of the new data with the past ones (step 806) using a received T (step 808).

In example embodiments, the method 800 includes comparing the statistics of all previously known domains Tᵢ∈T to identify a new domain (step 810). In some embodiments, identifying the new domain includes determining whether a change has occurred in the distribution of the new data and the past domains' data.

In example embodiments, if there is no change in the distribution of the new data (step 812), then the adaptation pipeline does not have to adapt the model (step 814) since the domain remains the same.

In example embodiments, otherwise (step 816), the adaptation pipeline has identified a new domain, and operation proceeds to Phase 2 (step 818).

### C.2.2. Phase 2—Data Labeling

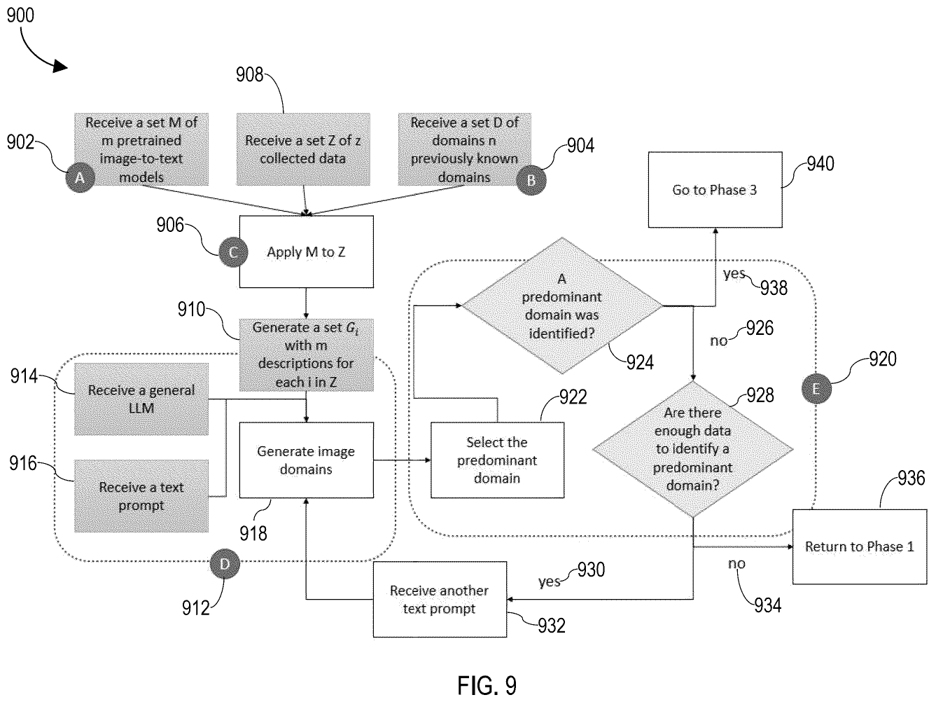

FIG. 9 shows a flowchart of an example method 900, in accordance with illustrative embodiments. In particular, FIG. 9 shows an example overview of the data labeling phase.

In example embodiments, one objective of this phase 900 is to automatically label a dataset of a new domain previously identified in phase 1. In general, obtaining labeled data is a costly and fundamental task for the application of learning models. Advantageously, in this sense, automatic labeling reduces the cost of the task while allowing efficient model training by increasing the amount of labeled data available.

In example embodiments, the method 900 includes receiving a set M of m models, M={M₁, M₂, . . . , Mₘ} (step 902). These models have been trained to recognize the same objects contained in the new domain. In some embodiments, the received models are pretrained captioning models (also referred to herein as image-to-text models), configured to transform an image input to a text output (e.g., BLIP). By way of example and not limitation, in the connected cars scenario, the models have been trained to recognize roads, traffic signs, pedestrians and other vehicles.

In example embodiments, the method 900 includes receiving a set of domains D={D₁, D₂, . . . , Dₙ}, containing the n previously known domains (step 904).

In example embodiments, the method 900 includes applying the m image-to-text models to the data collected from the new domain in Phase 1 (step 906). In example embodiments, for each image z in the set of new collected data Z (step 908), the method 900 includes running all m models to generate m descriptions (step 910). Two examples of such descriptions include “a car in a desert” and “a car on a snowy road.” By doing this, the adaptation system creates a set Gⁱ={G₁ⁱ, G₂ⁱ, . . . , Gₘⁱ} for each image containing all m descriptions generated by the image-to-text models.

In example embodiments, in group 912, the method 900 includes receiving a general LLM (step 914) and a prompt text (step 916) configured to analyze image descriptions to generate the image domains (step 918). Some example domains include “desert,” “forest,” “road,” “city,” and the like. In some embodiments, for each image i in the set of new collected data, phase 2 applies the LLM and the text prompt on Gⁱ to define its domain. It is noteworthy that, when applying the LLM and the prompt, each image can receive a different domain. It is also possible to have the same domains that are repeated for more than one image.

In example embodiments, in group 920, the method 900 includes analyzing the generated domains in order to identify a predominant one (step 922). In one implementation, in the case of a domain repeating itself mostly in the dataset, the adaptation system defines this domain as the predominant one. In example embodiments, the method 900 includes determining whether a predominant domain was identified (step 924). If a predominant domain was not identified (step 926), the method 900 includes determining whether enough data is available to identify a predominant domain (step 928). In some embodiments, if a predominant domain was unable to be identified (step 926) but sufficient data is available to identify a predominant domain (step 930), the adaptation system determines it is not possible to identify a recurring domain in the dataset.

In example embodiments, if it is not possible to identify a recurring domain in the dataset (steps 926, 930), the method 900 includes receiving another text prompt (step 932) and reapplying the LLM for one further iteration (step 918). If this problem persists (steps 922, 926, 934), then operation returns to phase 1 to collect more data (step 936).

In example embodiments, if the predominant domain is a completely novel domain (step 938), that means that the domain has never been previously seen before by any other device on the network, and operation proceeds to phase 3 (step 940) to adapt the model that is running on this edge to this new domain.

### C.2.3. Phase 3—Domain Adaptation

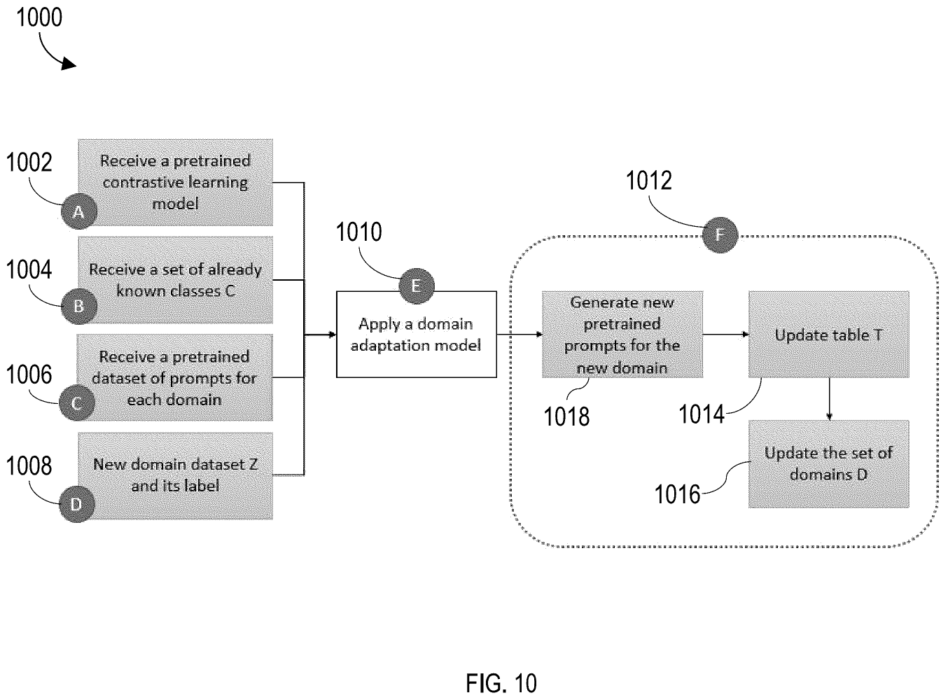

FIG. 10 shows a flowchart of an example method 1000, in accordance with illustrative embodiments. More particularly, FIG. 10 shows an example overview of the domain adaptation phase.

Example embodiments of the phase 1000 define how to apply a prompt learning-based method to adapt the model to a new domain. Advantageously, the prompt learning-based method helps avoid model retraining, allowing adaptation of the model while ensuring less costly learning with the use of prompts.

In example embodiments, the method 1000 includes receiving a pretrained contrastive learning model (step 1002). In some embodiments, the pretrained contrastive learning model is a multimodal model pretrained on text similarity. For example, the pretrained contrastive learning model can be CLIP, ConVIRT, or Transductive CLIP. Further details regarding CLIP, ConVIRT, and Transductive CLIP are disclosed in Radford, Alec, et al., “Learning transferable visual models from natural language supervision,” International conference on machine learning (2021), Zhang, Yuhao et al., “Contrastive learning of medical visual representations from paired images and text,” Machine Learning for Healthcare Conference (2022), and Huang, Junchu et al., “Transductive clip with class-conditional contrastive learning,” IEEE International Conference on Acoustics, Speech and Signal Processing (ICASSP) (2022), respectively, the entire contents of each of which are incorporated by reference herein for all purposes.

Additionally, in example embodiments the method 1000 includes receiving a set C of classes containing all j already known classes (step 1004). In one example application scenario, a pretrained contrastive learning model for connected cars was trained to recognize roads, traffic signs, pedestrians, and other vehicles in spring and summer locations.

In example embodiments, the method 1000 includes receiving a pretrained dataset of prompts for each already known and previously defined domain (step 1006). Additionally, in example embodiments the method 1000 includes receiving information about the new domain that has been identified (step 1008). In some embodiments, the information includes the images collected in Phase 1 for such new domain, along with the new label identified in Phase 2 for the new domain.

In example embodiments, the method 1000 includes applying a domain adaptation process using prompt learning to train the prompts for the new domain (step 1010). In some embodiments, the prompt learning-based domain adaptation process uses DAPL.

In example embodiments, in group 1012, the adaptation system is ready to update table T (step 1014) and the set of previously known domains D (step 1016) with statistics of the new domain, if a new domain has been identified. Accordingly, in example embodiments the method 1000 includes generating new pre-trained prompts to recognize the objects in the new domain (step 1018).

In some embodiments, the methods 600, 700, 800, 900, 1000 can be performed by the adaptation system 500, such as using the service 502.

While the various steps in the example methods 600, 700, 800, 900, 1000 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example methods 600, 700, 800, 900, 1000 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### D. Processing Platform

At least portions of the present adaptation pipeline can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present adaptation system. For example, containers can be used to implement respective processing devices providing compute and/or storage services of a cloud-based system. Again, containers may be used in combination with other virtualization infrastructure such as virtual machines implemented using a hypervisor.

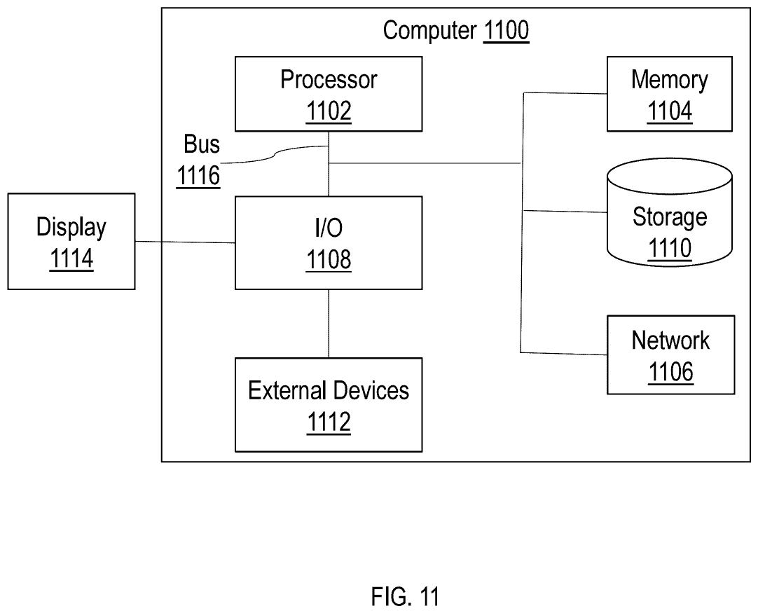

Illustrative embodiments of processing platforms will now be described in greater detail with reference to FIG. 11. Although described in the context of the present adaptation pipeline, these platforms may also be used to implement at least portions of other information processing systems in other embodiments.

FIG. 11 illustrates aspects of a computing device or a computing system in accordance with example embodiments. The computer 1100 is shown in the form of a general-purpose computing device. Components of the computer may include, but are not limited to, one or more processors or processing units 1102, a memory 1104, a network interface 1106, and a bus 1116 that communicatively couples various system components including the system memory and the network interface to the processor.

The bus 1116 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1100 typically includes a variety of computer-readable media. Such media may be any available media that is accessible by the computer system, and such media includes both volatile and non-volatile media, removable and non-removable media.

The memory 1104 may include computer system readable media in the form of volatile memory, such as random-access memory (RAM) and/or cache memory. The computer system may further include other removable/non-removable, volatile/non-volatile computer system storage media. By way of example only, the storage system 1110 may be provided for reading from and writing to a non-removable, non-volatile magnetic media (not shown and typically called a “hard drive”) in accordance with the present adaptation pipeline. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 1116 by one or more data media interfaces. As has been depicted and described above in connection with FIGS. 1-10, the memory may include at least one computer program product having a set (e.g., at least one) of program modules that are configured to carry out the functions of the embodiments as described herein.

The computer 1100 may also include a program/utility, having a set (at least one) of program modules, which may be stored in the memory 1104 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 1100 may also communicate with one or more external devices 1112 such as a keyboard, a pointing device, a display 1114, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 1108. Still yet, the computer system may communicate with one or more networks such as a local area network (LAN), a general wide area network (WAN), and/or a public network (e.g., the Internet) via the network adapter 1106. As depicted, the network adapter communicates with the other components of the computer system via the bus 1116. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-11, any component described with regard to a figure, in various embodiments of the invention, may be equivalent to one or more like-named components described with regard to any other figure. For brevity, descriptions of these components has not been repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
a memory comprising instructions; and
a processor communicatively coupled to the memory and configured to execute the instructions, the instructions comprising:
comparing statistics of data samples collected from an edge device against a plurality of known domain statistics to detect a new domain;
using descriptions generated for the collected data samples to determine a pseudo label associated with the new domain, wherein the pseudo label is generated using unsupervised machine learning (ML); and
applying a domain adaptation process using prompt learning based on the new domain and on the associated pseudo label to generate new prompts usable with a ML multimodal model for the new domain, and to update the known domain statistics to include statistics of the new domain, wherein the multimodal model is trained on text similarity.

2. The system of claim 1, wherein the descriptions for the collected data samples are generated by applying a plurality of ML image-to-text models to the collected data samples.

3. The system of claim 2, wherein using descriptions generated for the collected data samples further comprises:
obtaining a general large language model (LLM) and a text prompt configured to analyze image descriptions;
applying the LLM and the text prompt to the descriptions generated by the image-to-text models for the collected data samples to define domains for each image; and
selecting a label for a defined domain that is identified as predominant, to be the associated pseudo label, wherein the predominant domain is identified based on a frequency of domain occurrence in the generated descriptions.

4. The system of claim 1, wherein the domain adaptation process is unsupervised.

5. The system of claim 4, wherein the multimodal model trained on text similarity is a ML contrastive learning model.

6. The system of claim 5, wherein the domain adaptation process further comprises:
obtaining a set of known classes corresponding to the known domains; and
wherein the new prompts for the new domain are generated using the contrastive learning model, and the contrastive learning model is trained with a contrastive objective configured to align corresponding images and text representations of the known classes and the known domains in a shared feature space.

7. The system of claim 6, wherein the contrastive objective is further configured to maximize a similarity measure between a given image and a particular corresponding text representation as a positive pair, and to minimize the similarity measure between the given image and other text representations that are determined to be irrelevant as negative pairs.

8. The system of claim 7, wherein the similarity measure is a cosine similarity.

9. The system of claim 8, wherein the domain adaptation process is DAPL.

10. The system of claim 1, wherein the edge device is a camera in a connected car, and the data samples include image data from the camera.

11. A method comprising:
comparing statistics of data samples collected from an edge device against a plurality of known domain statistics to detect a new domain;
using descriptions generated for the collected data samples to determine a pseudo label associated with the new domain, wherein the pseudo label is generated using unsupervised ML; and
applying a domain adaptation process using prompt learning based on the new domain and on the associated pseudo label to generate new prompts usable with a ML multimodal model for the new domain, and to update the known domain statistics to include statistics of the new domain, wherein the multimodal model is trained on text similarity.

12. The method of claim 11, wherein the descriptions for the collected data samples are generated by applying a plurality of ML image-to-text models to the collected data samples.

13. The method of claim 12, wherein using descriptions generated for the collected data samples further comprises:
obtaining a general LLM and a text prompt configured to analyze image descriptions;
applying the LLM and the text prompt to the descriptions generated by the image-to-text models for the collected data samples to define domains for each image; and
selecting a label for a defined domain that is identified as predominant, to be the associated pseudo label, wherein the predominant domain is identified based on a frequency of domain occurrence in the generated descriptions.

14. The method of claim 11, wherein the domain adaptation process is unsupervised.

15. The method of claim 14, wherein the multimodal model trained on text similarity is a ML contrastive learning model.

16. The method of claim 15, wherein the domain adaptation process further comprises:
obtaining a set of known classes corresponding to the known domains; and
wherein the new prompts for the new domain are generated using the contrastive learning model, and the contrastive learning model is trained with a contrastive objective configured to align corresponding images and text representations of the known classes and the known domains in a shared feature space.

17. The method of claim 16, wherein the contrastive objective is further configured to maximize a similarity measure between a given image and a particular corresponding text representation as a positive pair, and to minimize the similarity measure between the given image and other text representations that are determined to be irrelevant as negative pairs.

18. The method of claim 17, wherein the similarity measure is a cosine similarity.

19. The method of claim 18, wherein the domain adaptation process is DAPL.

20. A non-transitory processor-readable storage medium having stored thereon program code of one or more software programs, wherein the program code when executed by at least one processing device causes the at least one processing device to perform the following steps:
comparing statistics of data samples collected from an edge device against a plurality of known domain statistics to detect a new domain;
using descriptions generated for the collected data samples to determine a pseudo label associated with the new domain, wherein the pseudo label is generated using unsupervised ML; and
applying a domain adaptation process using prompt learning based on the new domain and on the associated pseudo label to generate new prompts usable with a ML multimodal model for the new domain, and to update the known domain statistics to include statistics of the new domain, wherein the multimodal model is trained on text similarity.
